(19) United States
(12) Patent Application Publication
(10) Pub. No.: US 2006/0000366 A1
(43) Pub. Date: Jan. 5, 2006

(54) Apparatus for preparing and distributing ice-cream sandwich

(76) Inventor: Massimiliano Ricco, Parma (IT)

Correspondence Address: BELL, BOYD & LLOYD LLC, P. O. BOX 1135, CHICAGO, IL, 60690-1135, US

(21) Appl. No.: 10/526,824

(22) PCT Filed: Jul. 7, 2003
(86) PCT No.: PCT/EP03/07232

§ 371 Date: Mar. 4, 2005

(30) Foreign Application Priority Data
Sep. 6, 2002 (EP) 02020028.3

(51) Int. Cl. A47J 37/06

(52) U.S. Cl. 99/372

(57) ABSTRACT

An apparatus for preparing and distributing alimentary products formed of a portion of ice-cream, mousse, or the like contained between two biscuits, wafers, waffles or other bakery products comprises at least a biscuits dispenser; a container suited to receive the product; means suited to drive biscuits from said dispenser to said container; means for compressing the product and means 4 for ejecting the final product; as well as a lever or an equivalent means suited to control the movement of the above-mentioned elements.

### FIELD OF THE INVENTION

The present invention relates to an apparatus for preparing and selling ice-creams to the public and particularly an apparatus for preparing the so-called ice-cream sandwich just before selling it.

The ice-cream sandwich is made up of a portion of ice-cream contained between two biscuits, wafers, waffles or other bakery products having a circular or poligonal shape.

### BACKGROUND OF THE INVENTION

They are usually industrially prepared and sold in appropriate bags. In the handicraft way these ice-creams are prepared at points of sale by using well known manual instruments that accordingly do not require a detailed description.

Such known instruments have several drawbacks, among which the poor hygiene due to the direct contact of the ice-cream with the hands of the seller. A further drawback is the long time necessary to select the type of biscuit and the real preparation of the sandwich of ice-cream between the two external biscuit layers.

### SUMMARY OF THE INVENTION

The object of the present invention is therefore to provide an apparatus allowing a rapid, economic and hygienic preparation and sale of ice-cream sandwiches. This object is achieved through the apparatus according to the present invention whose features are specified in claim 1. Further features of the apparatus according to the present invention are specified in subsequent claims.

The apparatus for preparing and distributing ice-cream sandwiches according to the present invention, apart from allowing a rapid and economic preparation of the product in the greatest observance of hygienic rules, since the operator holds the above-mentioned product only when he gives it to the consumer, has also the advantage of being easily utilizable since the operator has only to move a lever besides to insert the ice-cream, and thus the apparatus can be utilized by everybody.

A further advantage of the apparatus for preparing and distributing ice-cream sandwiches according to the present invention is that this apparatus enables the consumer to choose even the biscuit among different available products.

Other advantages and features of the apparatus according to the present invention will be clear to those skilled in the art from the following detailed description of an embodiment thereof given with reference to the attached drawings, in which:

### BRIEF DESCRIPTION OF THE FIGURES

FIG. 1 shows a transparent lateral view of the apparatus according to the present invention during the product pressing step;

FIG. 2 shows a further view of FIG. 1 as simplified through the omission of some components;

FIG. 3 shows a perspective view of an enlarged detail of FIGS. 2 and 3; and

FIG. 4 shows in a lateral view several components of the apparatus not yet assembled.

### DETAILED DESCRIPTION OF THE INVENTION

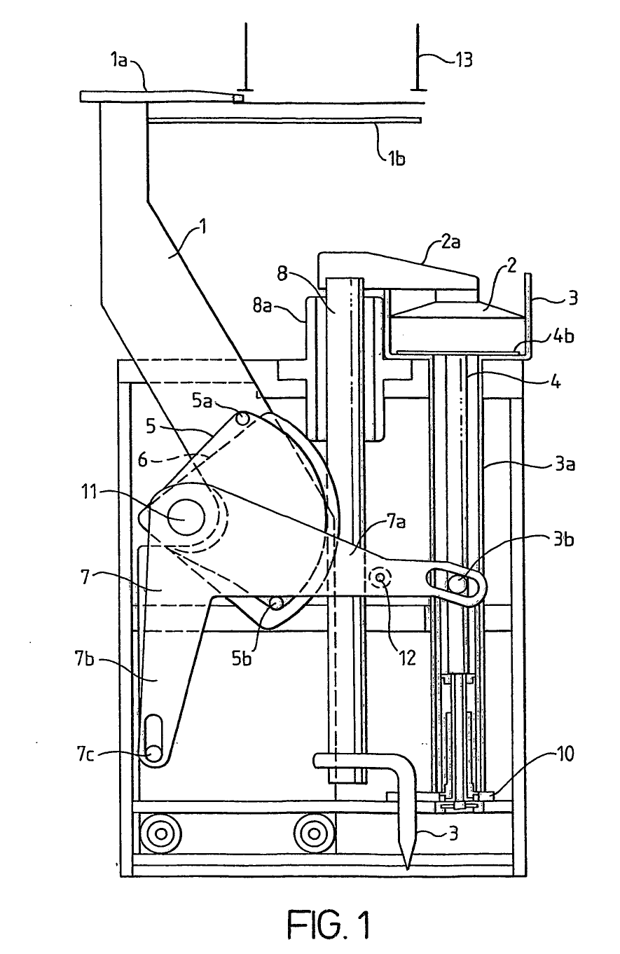

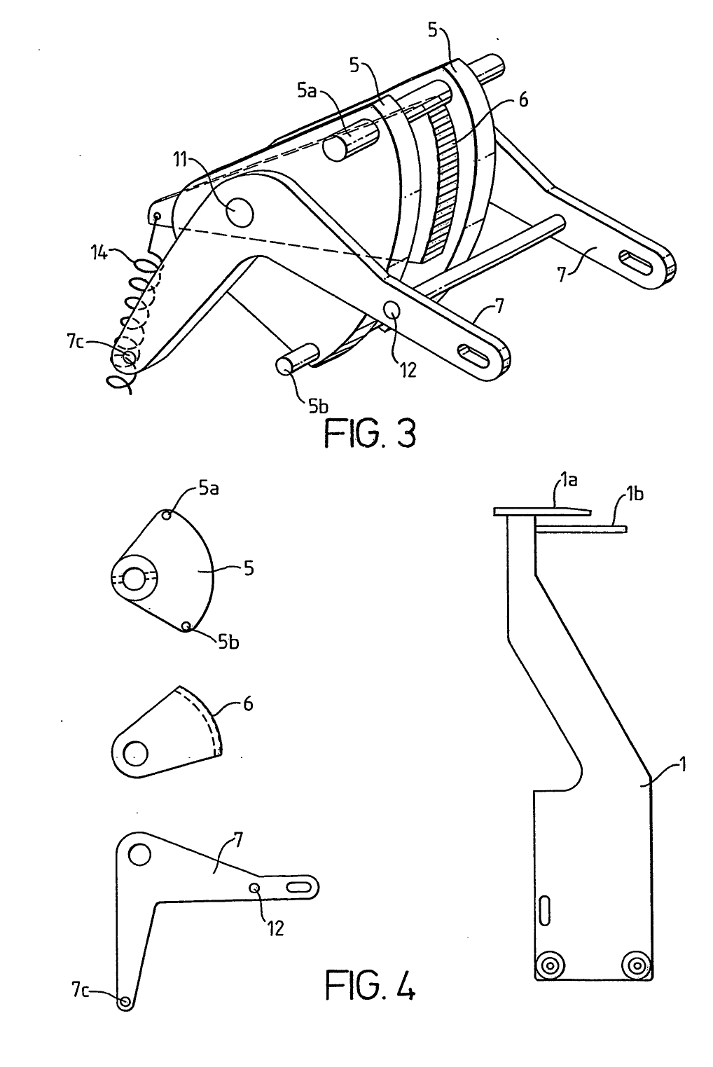

Referring to FIGS. 1 and 3, there is shown the apparatus for manufacturing and distributing ice-cream sandwiches according to the present invention comprising a piece 5 formed by a couple of equal and parallel circular sectors firmly connected to each other by pivots 5a and 5b. Such a piece 5 is integral with a control lever (not shown in the drawing) pivoted on a lateral face of the apparatus, and drives components 6 and 7, one of which being shown in FIG. 4, to rotate around pivot 11 of the lever. Component 7 is made up of a couple of equal and parallel compensators, firmly connected by pivot 12 and placed externally to the two circular sectors that form piece 5. This component 7 is linked to components 1 and 3 through buttonholes and countershafts.

Component 1 is made up of a couple of equal and firmly connected parallel carriages, each provided with two wheels sliding on guides formed at the apparatus base in such a way as to be able to translate horizontally. This carriage 1 is provided at the top with a pusher 1a having the function of individually pushing the biscuits out of one of dispensers 13. The apparatus is in fact provided at the top with a plate (not shown in the drawing) that can be manually rotated and on which several biscuits dispensers 13 are placed, each for every type. Such dispensers 13 consist of containers opened at the top, in order to be easily rechargeable, and provided at the base of a lateral wall with two openings mutually facing in such a way as to let pusher 1a enter one of them and to let a biscuit exit from the other one. Carriage 1 is firmly connected to two parallel supports 1b sliding underneath said plate and acting as guides for inserting into a container 3 each biscuit extracted from dispenser 13.

The latter is formed of a cylinder opened at the top that ends with a cylinder 3a having a shorter radius. Cylinder 3a, extending nearly to the base of the apparatus, contains a stem 4 which pushes a small plate 4b to translate vertically. This small plate 4b, located inside container 3, forms the lower mobile base of container 3. Stem 4 is linked to cylinder 3a through a mechanism which allows these two pieces to be firmly connected or to reciprocally translate as will be described further.

Component 6, placed between the two circular sectors that form piece 5, is a sector provided with a toothed profile engaging an helical profile formed on a shaft 8, thus controlling both translational and rotatory motion thereof. Shaft 8, supported by a sleeve 8a, is placed between cylinder 3a and pivot 11 and is firmly connected to plunger 2 through an arm 2a and an L-shaped element 9. This L-shaped element 9 ends with a nose which, as a result of the rototranslatory motion of shaft 8, gets into a buttonhole of an element 10 acting as a linkage between cylinder 3a and stem 4.

The preparation of ice-cream sandwiches according to the present invention is carried out in four steps to which three different conditions of the apparatus correspond: the first step is the biscuit dispensing step to which corresponds the first apparatus condition, named dispensing mode; after having reset the apparatus in the resting mode, the second step is carried out, i. e. the step of inserting ice-cream inside the container; the third step consists in rearranging the apparatus in the dispensing mode so as to place a second biscuit on the ice-cream portion; finally the fourth step is carried out wherein the apparatus is arranged in pressing mode during which the product is subjected to compression and then ejected from the apparatus. The passage from a mode to another one occurs by moving the control lever from a position to another.

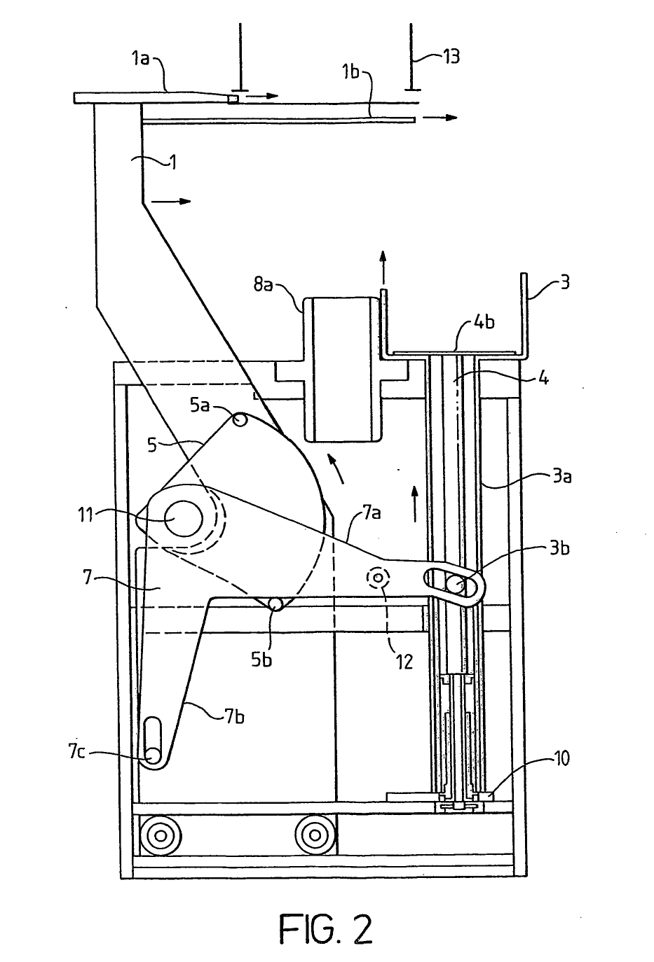

With reference to FIGS. 2 and 3, there is shown how the first step is carried out. The arrows indicate the rotation or translation sense of the various elements. By rotating counterclockwise the control lever with respect to the starting position corresponding to the resting mode, and by so positioning it in the dispensation mode, the circular sector 5, integral with the control lever, rotates in the sense indicated by arrow, thus driving also compensator 7 to rotate through pivot 5b. The counterclockwise stroke of the circular sector 5 is, anyway, short enough to not risk to drive also toothed sector 6 to rotate through pivot 5b. Compensator 7 has a first arm, 7a provided with a buttonhole, and a second arm, 7b provided with a countershaft 7c, at which, on cylinder 3a and on carriage 1 there are respectively a countershaft 3b and a buttonhole through which compensator 7 is connected to components 1 and 3a.

These linkages work in such a way that, when compensator 7 rotates, cylinder 3a, and thus container 3, that in this step is integral therewith, moves vertically upwards thanks to countershaft 3b which changes the rotatory motion of compensator 7 into a translatory motion of cylinder 3a. In the same time, carriage 1, thanks to countershaft 7c, moves horizontally in the direction indicated by the arrow. As carriage 1 moves, also pusher 1a integral therewith, moves pushing the last biscuit of the stack outside the biscuits dispenser 13. Since also supports 1b are integral with element 1, as pusher 1a pushes the biscuit, the latter lays on these supports 1b which gradually move forward together with the same pusher 1a and drive the biscuit until it comes exactly over container 3. At this point, coinciding with the point in which pusher 1a reaches the stop, a suitable device opens the two supports 1b so to let the biscuit drop in the underneath container 3, which meanwhile has been lifted through the mechanism described above.

The biscuit is preferably put down on a special wrapping, previously placed on the bottom of container 3, which wrapping is intended to avoid that the operator cleans the apparatus after having prepared each ice-cream sandwich, and that the final product comes into contact with the hands of the operator when he gives it to the consumer.

Once the first biscuit has been placed into container 3, the operator can rearrange the lever in resting mode. This allows the compensator 7 to rotate clockwise as returned by a spring not shown in the drawing. In this way pusher 1, driven by compensator 7, moves back until it comes to the starting position, and container 3, and thus cylinder 3a together with stem 4 fixed thereto, lower again.

At this point the second preparation step of the product is carried out. This step consists of manually inserting the ice-cream on the surface of the biscuit placed inside container 3, with an appropriate proportioner spoon which, to this end, is leant at an appropriate gap formed on the lateral surface of container 3.

The third preparation step of the product consists of dispensing the second biscuit on the inserted ice-cream portion, and accordingly the procedure is the same as in the first step by arranging the lever in the distributing mode.

With reference to FIGS. 1 and 3, there is shown how the last step, i. e. the pressing step wherein the lever is rotated clockwise so as to arrange it in the pressing mode, is carried out. The rotation of the lever in this direction makes circular sector 5 to rotate in the sense opposite to the one in which the same sector 5 rotates in the distributing step. Sector 5, through pivot 5a, drives toothed sector 6 to rotate. The latter, together with the helicoidal profile formed on shaft 8, constitutes a gear mechanism. Therefore the rotation of toothed sector 6 causes a rototranslation of shaft 8 that is transmitted also to plunger 2 which, by rotating, comes over container 3, and by moving downwards presses the product contained therein. Simultaneously, since L-shaped element 9 is integral with shaft 8, it also moves with a rototranslatory motion so to be inserted into the buttonhole located at one end of element 10. This element 10 is thus caused, by the motion of L element 9, to move horizontally in the direction bringing it near to shaft 8. This movement releases stem 4, up to this moment integral with cylinder 3a thanks to a removable catch, and, as the lever is rearranged in the resting mode, a spring pushes upwards the stem 4. Since the latter is integral with plate 4b, it pushes also the final product upwards and hence outside container 3, thus making it easy for the operator to take it and deliver it to the consumer. Simultaneously, the toothed sector 6 is brought back in resting position by a spring 14. The latter is located in the area of toothed sector 6 opposite to the toothed profile with respect to pivot 11. This spring 14, having the other end fixed to the frame of the apparatus, is drawn during the pressing step and then released when the lever is rearranged in the resting mode while dragging with it the toothed sector 6. In order to avoid that the latter, once returned by the spring, goes on rotating thus going beyond the desired position, a locking device (not shown in the figure) is used. The toothed sector 6 causes in turn shaft 8, through the gear mechanism, to move upwards and, with it, also arm 2a, plug 2, and L-shaped element 9, which element is in this way removed from the buttonhole of piece 10. The latter gets back in the starting position through a spring. At this point it is sufficient to push plate 4b on the bottom to get the apparatus ready for preparing another ice-cream sandwich.

Possible variations and/or additions can be made by those skilled in the art to the embodiment here described and illustrated without departing from the scope of the invention. For example it could be envisaged to substitute supports 1b by guides fixed to the frame, which bend inwardly to let the biscuit drop when the pusher reaches the stop.

It could be also envisaged to automate the apparatus by providing it with devices for the automatic control of the sequence of various steps.

The apparatus could further be provided with electric or pneumatic actuators instead of the manually working lever.

For constructing the apparatus according to the present invention it is possible to utilize any known material regarded as suitable to construct apparatuses of conventional type.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. An apparatus for preparing and distributing alimentary products formed of a portion of ice-cream, mousse, or the like contained between two bakery products, comprising at least a biscuit dispenser; a container suited to receive the product; means suited to drive the bakery product from the dispenser to said container; means for compressing the product and means for ejecting the final product; and control means suited to control the movement of elements of the apparatus.

2. The apparatus according to claim 1, wherein the control means act on a pivot whereon there is keyed a circular sector provided with two pivots that rotate a toothed sector and a compensator both rotating around said pivot of the circular sector.

3. The apparatus according to claim 1 wherein the control means consist of a lever.

4. The apparatus according to claim 1 wherein the control means consist of electric or pneumatic actuators acting on the pivot.

5. An apparatus according to claim 1 comprising linkages so constructed and arranged so that as the container moves near to the bakery product dispenser, a pusher pushes a bakery product on one or more supports which moves forward to cause the biscuit to drop when it is over the container.

6. The apparatus according to claim 5, wherein the linkages are coupled to two arms of the compensator which are respectively suited to make a cylinder, integral with the container, move upwards, and cause a carriage, integral with pusher and with supports, to move horizontally.

7. An apparatus according to claim 1 comprising linkages that, while the pressing means are compressing the product, a mechanism, acting in such a way as to prepare the ejection of the final product, is set in motion.

8. The apparatus according to claim 7 wherein the pressing means are a plunger and said linkages are carried out through a shaft connected to said plunger through an arm and to an element acting in such a way as to unengage an element which prior thereto caused a stem to be firmly connected to the cylinder.

9. An apparatus according to claim 1 comprising at a top thereof a rotating plate on which at least two dispensers of bakery products rest.

10. An apparatus according to claim 1 wherein the bakery product is selected from the group consisting of biscuits, wafers, and waffles.

11. An apparatus for preparing and distributing products formed of a portion of ice-cream between two bakery products comprising:
at least a bakery product dispenser;
a container for receiving the product;
a member for moving the bakery product from the dispenser to the container;
a member for compressing the product;
a member for ejecting the final product; and
a member that controls the movement of at least certain elements of the apparatus.
